(19) United States
(12) Patent Application Publication
(10) Pub. No.: US 2023/0314456 A1
(43) Pub. Date: Oct. 5, 2023

(54) ANALYSIS WORK SUPPORT DEVICE AND ANALYSIS WORK SUPPORT SOFTWARE

(71) Applicant: SHIMADZU CORPORATION, Kyoto-shi, Kyoto (JP)

(72) Inventors: Tatsuki OKUBO, Kyoto-shi (JP); Tomeonori OSHIKAWA, Kyoto-shi (JP); Yuko KOBAYASHI, Kyoto-shi (JP); Yoshiki TAINAKA, Kyoto-shi (JP); Kohei SUZUKI, Kyoto-shi (JP)

(73) Assignee: SHIMADZU CORPORATION, Kyoto-shi, Kyoto (JP)

(21) Appl. No.: 18/040,928

(22) PCT Filed: Apr. 26, 2021
(86) PCT No.: PCT/JP2021/016671

§ 371 Date: Feb. 7, 2023

(30) Foreign Application Priority Data
Jan. 9, 2020 (JP) 2020-146823

(51) Int. Cl. G01N 35/00; G06F 3/04842

(52) U.S. Cl. CPC G01N 35/00722; G06F 3/04842; G01N 2035/0091

(57) ABSTRACT

A device that supports analysis work of executing a protocol for disposing a predetermined sample in all or some predetermined sample disposing portions among a plurality of sample disposing portions provided in a sample housing member and for performing measurement, includes: a storage unit in which protocols are stored; a display unit; a protocol selection input reception unit to receive an input for selecting a protocol; a sample position display unit to display information on a position of the sample disposing portion and information on the sample corresponding to the protocol input to the protocol selection input reception unit on the display unit; a display item selection checkbox to receive selection of the information on the position of the sample disposing portion and/or the information on the sample; and a display switching unit to switch display by the sample position display unit depending on the selection.

### CROSS REFERENCE TO RELATED APPLICATIONS

This application is a National Stage of International Application No. PCT/JP2021/016671 filed on Apr. 26, 2021, claiming priority based on Japanese Patent Application No. 2020-146823 filed on Sep. 1, 2020.

### TECHNICAL FIELD

The present invention relates to a device and computer software that support analysis work.

### BACKGROUND ART

Alzheimer's disease is known as a disease that causes dementia. When Alzheimer's disease is affected, symptoms such as deterioration in memory ability and cognitive ability gradually progress. Therefore, it is effective to detect Alzheimer's disease at an early stage before onset of dementia and to start treatment.

It is known that Alzheimer's disease patients accumulate substances called amyloid beta in the brain (for example, Non Patent Literature 1). Conventionally, the accumulation state of amyloid beta in the brain was examined using a positron emission tomography apparatus (PET), but the examination using PET takes a long time and is expensive. Patent Literature 1 proposes a method in which the intensities of ions derived from two specific peptides contained in the blood of a subject are measured by mass spectrometry, and the ratio of the intensities is calculated to examine the accumulation state of amyloid beta. This method makes it possible to diagnose Alzheimer's disease more quickly and inexpensively than using PET. In addition, it is possible to promptly and efficiently diagnose Alzheimer's disease of a plurality of subjects.

In the method described in Patent Literature 1, a MALDI-TOF mass spectrometer is used. In the MALDI-TOF mass spectrometer, a matrix-added sample disposed in a well of a sample plate is irradiated with laser light to generate ions (MALDI), and the ions are introduced into a time-of-flight (TOF) mass separator. Various ions introduced into the mass separation unit fly in the TOF space with a flight time corresponding to each mass-to-charge ratio and are detected.

As described above, in the method described in Patent Literature 1, the intensity of ions derived from each of the two specific peptides contained in the blood of a subject is measured to examine the accumulation state of amyloid beta. Therefore, in order to perform an accurate examination, it is necessary to accurately measure the positions and intensities of the mass peaks. That is, it is required to perform mass spectrometry of a sample with constant mass accuracy and sensitivity at all times. When it is required to ensure constant mass accuracy and sensitivity as described above, mass spectrometry is performed according to a predetermined standard operation procedure (SOP) of analysis.

Here, an example of a standard operation procedure for mass spectrometry of a sample using a MALDI-TOF mass spectrometer is described. A sample plate used in MALDI is partitioned into square individual regions, and a well in which a calibrant is disposed is provided at the center of each individual region, and wells in which a sample is disposed are provided at four locations around the center well. The calibrant is a substance used for mass calibration that produces ions with known mass-to-charge ratios.

First, a first protocol for determining the intensity of laser light that is optimal for sample ionization is executed. In the first protocol, a plurality of individual regions on the sample plate as many as the number of preset candidate values of the intensity of laser light are used. A standard sample containing a specified amount of a target substance is disposed in the four wells of each individual region, and a calibrant is disposed in the center well. In the first protocol, the same standard sample and the same calibrant are disposed in all individual regions. After the standard sample and the calibrant are disposed, the sample plate is set in the mass spectrometer. After that, laser light having an intensity of first candidate value is irradiated onto the calibrant disposed in the first individual region, and the mass spectrometer is mass-calibrated by comparing the detection result of the generated ions with the actual mass-to-charge ratio of the ions. After the measurement of the calibrant, each of the samples disposed in the four wells in the same individual region is similarly irradiated with the laser light having the intensity of the first candidate value, and the generated ions are detected. Then, the detection intensities of the ions obtained by the four times of mass spectrometry are averaged, and the detection sensitivity of the ions with respect to the laser light of the intensity for the first candidate value is obtained from the detection intensity of the ions of a predetermined mass-to-charge ratio. By performing such mass spectrometry by irradiating standard samples disposed in all individual regions with laser light having intensities of different candidate values, detection sensitivity of ions for each of the candidate values of the intensity of the laser light is obtained, and the intensity of the laser light with which the actual sample is to be irradiated is determined on the basis of the result. In general, a candidate value of the intensity of the laser light having the highest detection sensitivity is selected.

After the intensity of the laser light with which the sample is irradiated is determined, a second protocol for determining a correction value related to the relationship between the content of the target substance and the detection intensity of ions is then executed. In the second protocol, a plurality of standard samples, each of which contains a different specified amount of the target substance, are used, and a plurality of individual regions as many as the plurality of samples are used. The same standard sample is placed in four wells of each individual region, and a calibrant is placed in the center well. The calibrant is common to all the individual regions. After the standard sample and the calibrant are placed, the sample plate is set in the mass spectrometer. After that, the laser light having the intensity determined in the first protocol is emitted to the calibrant disposed in the first individual region, and the mass spectrometer is mass calibrated in the same manner as in the execution of the first protocol. After measuring the calibrant, each of the standard samples disposed in the four wells in the same individual region is similarly irradiated with laser light of the intensity determined by the first protocol. The detection intensities of the ions obtained by the four times of mass spectrometry are averaged, and the relationship between the content of the target substance contained in the standard sample and the detection intensity of the ions is determined from the detection intensities of the ions having a predetermined mass-to-charge ratio. This series of mass spectrometry is performed in all individual regions. Then, a correction value of the detection intensity is determined so that the detection intensity of the ions of the target substance of each specified amount becomes a predetermined intensity.

After executing the above two protocols, a third protocol for executing mass spectrometry of a measurement target sample is conducted. In the third protocol, a standard sample is disposed in the first individual region, and measurement target samples are sequentially disposed from the next individual region. When the predetermined number of measurement target samples are disposed, the standard sample is disposed again in the next individual region. That is, the standard sample and the measurement target samples are disposed so as to measure the standard sample every time a predetermined number of measurement target samples are subjected to mass spectrometry. The standard sample is used to confirm that mass spectrometry is properly performed at each time point. Also in the third protocol, similarly to the above two protocols, a calibrant for mass calibration is disposed in each individual region. Then, mass spectrometry is sequentially performed from the first individual region, and each of the measurement target samples disposed in the four wells in each individual region is irradiated with laser light having the intensity determined by the first protocol. The detection intensities of the ions obtained by the four times of mass spectrometry are averaged, and the detection intensity of the ions having a predetermined mass-to-charge ratio is corrected by the correction value determined by the second protocol to determine the intensity of the ions derived from the target substance contained in the measurement target sample.

### CITATION LIST

### Patent Literature

Patent Literature 1: WO 2015/178398 A

### Non Patent Literature

Non Patent Literature 1: “High performance plasma amyloid-β biomarkers for Alzheimer's disease”, Akinori Nakamura, Naoki Kaneko, Victor L. Villemagne, Takashi Kato, James Doecke, Vincent Dore, Chris Fowler, Qiao-Xin Li, Ralph Martins, Christopher Rowe, Taisuke Tomita, Katsumi Matsuzaki, Kenji Ishii, Kazunari Ishii, Yutaka Arahata, Shinichi Iwamoto, Kengo Ito, Koichi Tanaka, Colin L. Masters, Katsuhiko Yanagisawa, Nature, 2018, 554 pp. 249-254

### SUMMARY OF INVENTION

### Technical Problem

In the method described in Patent Literature 1, since different samples are measured in each protocol, it is necessary to correctly dispose the samples in respective wells in each individual region when each protocol is executed. However, it is not easy for a person unskilled in analysis to dispose different samples for each protocol at the correct position of the well of each individual region, and there is a problem in that an incorrect sample may be disposed in the well.

In the above description, a case where a sample is subjected to mass spectrometry using a MALDI-TOF mass spectrometer has been described as an example, but there is a similar problem in analysis of a sample using another analysis device.

A problem to be solved by the present invention is to provide a technique for supporting analysis work in analysis for executing a plurality of protocols so that a user can correctly place and measure a predetermined sample for each protocol in a sample disposing portion provided in a sample housing member.

### Solution to Problem

The present invention made to solve the above problems is a device which supports analysis work of executing a protocol for disposing a predetermined sample in all or some predetermined sample disposing portions among a plurality of sample disposing portions provided in a sample housing member set in an analysis device and for performing measurement, the device including:
a storage unit in which a plurality of protocols, and information on a position of the sample disposing portion and the sample corresponding to each of the plurality of protocols are stored;
a display unit;
a protocol selection input reception unit configured to receive an input for selecting one of the plurality of protocols;
a sample position display unit configured to read, from the storage unit, information on a position of the sample disposing portion and information on the sample corresponding to the protocol input to the protocol selection input reception unit and display the information on the position and the information on the sample on the display unit;
a display item selection unit configured to receive selection of one or both of the information on the position of the sample disposing portion and the information on the sample; and
a display switching unit configured to switch display of the display unit by the sample position display unit depending on selection through the display item selection unit.

In addition, another mode of the present invention made to solve the above problems is a program which supports analysis work of executing a protocol for disposing a predetermined sample in all or some predetermined sample disposing portions among a plurality of sample disposing portions provided in a sample housing member set in an analysis device and for performing measurement, the program causing a computer including
a storage unit in which a plurality of protocols, and information on a position of the sample disposing portion and the sample corresponding to each of the plurality of protocols are stored, and
a display unit
to operate as:
a protocol selection input reception unit configured to receive an input for selecting one of the plurality of protocols;
a sample position display unit configured to read, from the storage unit, information on a position of the sample disposing portion and information on the sample corresponding to the protocol input to the protocol selection input reception unit and display the information on the position and the information on the sample on the display unit;
a display item selection unit configured to receive selection of one or both of the information on the position of the sample disposing portion and the information on the sample; and
a display switching unit configured to switch display of the display unit by the sample position display unit depending on selection through the display item selection unit.

### Advantageous Effects of Invention

An analysis work support device and an analysis work support program according to the present invention support analysis work of executing a protocol for disposing a predetermined sample in all or some predetermined sample disposing portions among a plurality of sample disposing portions provided in a sample housing member set in an analysis device and for performing measurement. A storage unit stores in advance pieces of information on a plurality of protocols, that is, the information including the information on a sample to be measured and the information on a position of a sample disposing portion in which the sample is to be disposing, in each protocol. When the user selects one of the plurality of protocols, the sample position display unit reads, from the storage unit, information on a position of the sample disposing portion and the sample corresponding to the protocol, and displays them on the display unit. For example, in a case of a sample plate provided with a plurality of sample disposing portions in a lattice pattern, the information on the sample is displayed by the number of samples to be disposing according to the protocol with the sample disposing portion located at the upper right end on the screen as a base point when the sample plate is displayed in a predetermined direction. Therefore, when trying to execute each protocol, the user can easily confirm which sample is to be disposing at which position, and correctly dispose and measure the sample.

In addition, the user can display what the user wants to confirm on the display unit by selecting one or both of the information on the position of the sample disposing portion and the information on the sample. For example, in a case where the information on the sample is text information, if both the information on the position of the sample disposing portion and the text information on the sample are displayed, both pieces of information may overlap each other, and thus it may be difficult to see them. In the present invention, by selecting one or both of the information on the position of the sample disposing portion and the information on the sample through the display item selection unit, the display of the display unit can be switched to enhance the visibility of the item to be seen by the user.

### BRIEF DESCRIPTION OF DRAWINGS

FIG. 1 is a configuration diagram of a main part of an analysis system including an embodiment of an analysis work support device and an analysis work support program according to the present invention.

FIG. 2 is an example of a display screen in the analysis system of the present embodiment.

FIG. 3 is a display example of a sample plate schematic display unit displayed when an analysis protocol of laser power selection in the present embodiment is executed.

FIG. 4 is another display example of a sample plate schematic display unit displayed when an analysis protocol of laser power selection in the present embodiment is executed.

FIG. 5 is yet another display example of a sample plate schematic display unit displayed when an analysis protocol of laser power selection in the present embodiment is executed.

FIG. 6 is a display example of a sample plate schematic display unit displayed when an analysis protocol of intensity ratio calibration in the present embodiment is executed.

FIG. 7 is another display example of a sample plate schematic display unit displayed when an analysis protocol of intensity ratio calibration in the present embodiment is executed.

FIG. 8 is a display example of a sample plate schematic display unit displayed when an analysis protocol of specimen analysis in the present embodiment is executed.

FIG. 9 is another display example of a sample plate schematic display unit displayed when an analysis protocol of specimen analysis in the present embodiment is executed.

FIG. 10 is a configuration diagram of a main part of an analysis system of a variation.

### DESCRIPTION OF EMBODIMENTS

Hereinafter, an embodiment of an analysis work support device and an analysis work support program according to the present invention will be described with reference to the drawings. The analysis work support device and the analysis work support program of the present embodiment are used to support a series of analysis work in which the intensity of ions derived from each of the two types of specific peptides contained in blood collected from a subject is measured by mass spectrometry, and the accumulation state of amyloid beta is examined from the intensity ratio.

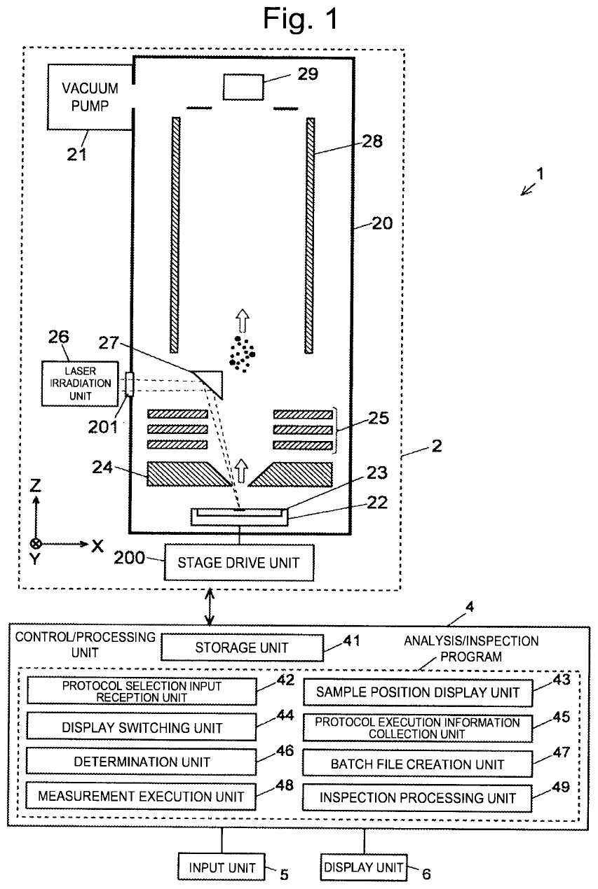

FIG. 1 is a configuration diagram of a main part of an analysis system 1 including an analysis work support device and an analysis work support program according to the present embodiment. The analysis system 1 roughly includes an analysis unit 2 and a control/processing unit 4, and the analysis work support device and the analysis work support program are incorporated in a part of the control/processing unit 4.

The analysis unit 2 is a MALDI-TOF mass spectrometer in which a MALDI ion source and a linear time-of-flight mass separator (TOF) are combined.

The analysis unit 2 includes a chamber 20 evacuated by a vacuum pump 21. Inside the chamber 20, a sample stage 22 on which a sample plate 23 is held, an extraction electrode 24, an acceleration electrode 25, a flight tube 28 forming a flight space inside, and a detector 29 are disposed. The wall surface of the chamber 20 is provided with a window 201 that transmits light in a wavelength band of laser light to be described later. A laser irradiation unit 26 including a laser light source is disposed outside the chamber 20 with the window 201 interposed between them, and a mirror 27 is disposed inside the chamber 20. The sample stage 22 is movable in a horizontal direction (X-axis and Y-axis directions) and a vertical direction (Z-axis direction) by a stage drive unit 200 including a motor and the like.

At the time of measuring a sample, the sample stage 22 is moved by the stage drive unit 200, and the well on which the sample is disposed of the sample plate 23 held on the sample stage 22 is aligned with the irradiation position of the laser light. Subsequently, the laser irradiation unit 26 emits laser light having a predetermined intensity for a predetermined time. After passing through the window 201, the emitted laser light is reflected downward by the mirror 27 and emitted to the sample disposed in the well on the sample plate 23.

Upon being irradiated with the laser light, components in the sample are vaporized and ionized. The generated ions derived from the sample components are extracted in the vertical (Z-axis) direction from the vicinity of the surface of the sample plate 23 by the action of an electric field formed by a DC voltage applied to the extraction electrode 24 from a power source unit (not illustrated). The ions reach the acceleration electrode 25, and receive kinetic energy by the action of an acceleration electric field formed by a DC voltage applied from the power source unit (not illustrated) to the acceleration electrode 25. As a result, the ions are accelerated in the vertical (Z-axis) direction, and are introduced into a flight space with no electric field and no magnetic field inside the flight tube 28. While flying in this flight space, the ions are separated in time according to the mass-to-charge ratio m/z and reach the detector 29. The detector 29 sequentially detects the ions that have reached it, and a detection signal corresponding to the amount of the ions is output from the detector 29 and sequentially stored in a storage unit 41 described later.

In addition to the storage unit 41, the control/processing unit 4 includes, as functional blocks, a protocol selection input reception unit 42, a sample position display unit 43, a display switching unit 44, a protocol execution information collection unit 45, a determination unit 46, a batch file creation unit 47, a measurement execution unit 48, and an inspection processing unit 49. An entity of the control/processing unit 4 is a general personal computer, and each functional block described above is embodied by a processor executing an analysis program installed beforehand. In addition, an input unit 5 including a keyboard, a mouse, or the like for a user to perform an input operation and a display unit 6 including a liquid crystal display or the like are connected to the control/processing unit 4.

The storage unit 41 stores information on four analysis protocols. The four analysis protocols are for performing laser power selection, intensity ratio calibration, standard plasma analysis, and specimen analysis, respectively. The storage unit 41 also stores information on the execution order of the analysis protocol. The analysis protocols in the present embodiment are defined to be executed in the order of laser power selection, intensity ratio calibration, standard plasma analysis, and specimen analysis. However, standard plasma analysis can be omitted (that is, the specimen analysis can be performed even if the standard plasma analysis has not been performed).

In addition, the storage unit 41 stores sample information (sample type, sample name, etc.) and analysis parameter information used in each of the four analysis protocols. In the laser power selection, analysis parameters including the use of a standard sample containing a specified amount of peptide to be measured and five setting values (−10, −5, 0, +5, +10) related to the value of laser power are stored. The five setting values (−10, −5, 0, +5, +10) related to the value of laser power are values that are increased or decreased to the reference value of the laser power input by the user when the intensity of the laser light with which the sample is irradiated is determined in the analysis protocol of the laser power selection described later.

In the intensity ratio calibration, analysis parameters including the use of four types of standard samples (IC-1, IC-2, IC-3, IC-4, IC-5) having different peptide contents to be measured and a value of laser power based on the inspection result of the previous analysis protocol (laser power selection) are stored.

In the standard plasma analysis, analysis parameters including the use of standard plasma and the value of laser power based on the inspection result of the previous analysis protocol (laser power selection) are stored. Note that the standard plasma is prepared by subjecting human plasma to pretreatment, and the content of the peptide to be measured is known.

In the specimen analysis, analysis parameters including the use of the above standard plasma and plasma extracted from blood collected from an unexamined subject and including the value of laser power based on the inspection result of the previous analysis protocol (laser power selection) are stored. In the present embodiment, the case of using measurement target samples 1-12 collected from 12 subjects will be described, but the number of subjects can be appropriately changed within a range that can be set in the sample plate 23.

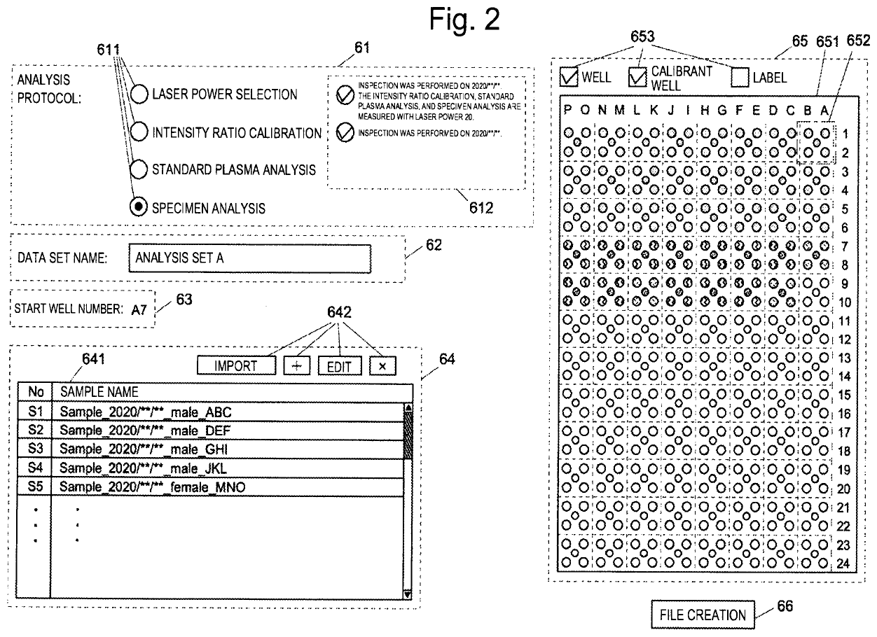

Next, a procedure of analysis using the analysis system 1 of the present embodiment will be described. When the user instructs the start of the analysis, a screen as illustrated in FIG. 2 is displayed on the display unit 6. FIG. 2 is a display example of a state in which the analysis protocol of the specimen analysis is selected after the analysis protocols of the laser power selection and the intensity ratio calibration are executed.

The screen illustrated in FIG. 2 includes an analysis protocol selection part 61, a data set name input part 62, a start well number display part 63, a sample information display part 64, and a sample plate display part 65.

The analysis protocol selection part 61 is provided with the above four analysis protocol names and selection buttons 611, and an analysis protocol implementation information display area 612. When the user selects one of the four selection buttons 611, the input of the corresponding analysis protocol is received by the protocol selection input reception unit 42. In the analysis protocol implementation information display area 612, information on an analysis protocol executed is displayed.

The data set name input part 62 is provided with a field for inputting a data set name of data acquired by executing a series of analysis protocols. In the starting well number display part 63, a well number for setting the first sample in the analysis protocol to be executed next is displayed. The sample information display part 64 is provided with a sample name display table 641 that indicates a relationship between a label displayed on the sample plate display part 65 to be described later and the sample name of the sample selected in the analysis protocol selection part 61, and data editing buttons 642. The data editing buttons 642 include an “import” button for reading a file including a sample name and displaying the file as the sample name display table 641, a “+” button for adding a display field to the sample name display table 641, a “x” button for deleting the display field from the sample name display table 641, and an “edit” button 642 for editing the sample name displayed in the sample name display table 641.

The sample plate display part 65 is provided with a sample plate schematic display area 651 and a display item selection checkbox 653. In the sample plate used in the present embodiment, as illustrated in the sample plate schematic display area 651, individual regions 652 in which samples are disposed are arranged in a lattice pattern. The same sample is disposed in the wells located at the four corners of each individual region 652, and a calibrant is disposed in the well located at the center. Below the sample plate display unit 65, a file creation button 66 for creating a batch file for executing each analysis protocol is displayed.

First, when the user selects the selection button 611 of the analysis protocol (laser power selection) to be executed first among the analysis protocols displayed on the analysis protocol selection part 61, the protocol selection input reception unit 42 receives an input of the protocol for laser power selection. When the analysis protocol is selected, the determination unit 46 reads information on the implementation order of the analysis protocols stored in the storage unit 41. Since the laser power selection protocol is an analysis protocol to be executed first, the determination unit 46 terminates the operation as it is. In addition, the user inputs the name of the data set. The display unit 6 displays a screen for inputting a reference value of laser power to be used when the protocol for laser power selection is executed, and prompts the user to input the reference value. The reference value, for example, within a range of 15 to 170 can be input. Hereinafter, a case where “15” is input as a reference value will be described as an example.

Next, the sample position display unit 43 reads, from the storage unit 41, the information on the sample and the analysis parameter corresponding to the analysis protocol (laser power selection) received by the protocol selection input reception unit 42. As described above, for the protocol of laser power selection, analysis parameters including the use of a standard sample containing a specified amount of peptide to be measured and five setting values (−10, −5, 0, +5, +10) related to the value of laser power are stored. Upon reading these pieces of information, the sample position display unit 43 calculates a value (value of laser power actually emitted to the sample; 5, 10, 15, 20, 25 in this example) obtained by increasing or decreasing the reference value of the laser power input by the user by five setting values, and displays these pieces of information at the position of the well in which the sample is to be disposed in the sample plate schematic display area 651.

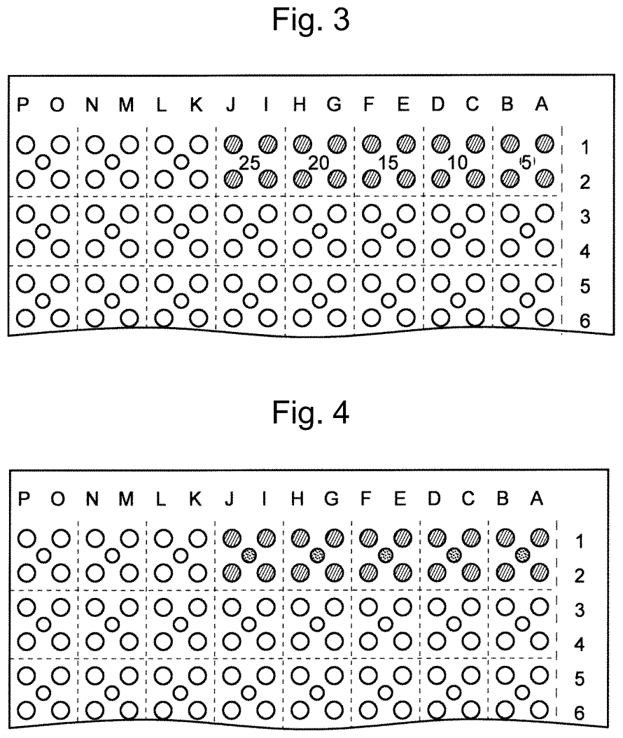

A display example of the sample plate schematic display area 651 by the sample position display unit 43 is illustrated in FIG. 3. In the present embodiment, the sample position display unit 43 extracts five individual regions arranged in the lateral direction with the individual region 652 positioned at the upper right corner as the first region among the unused individual regions 652 (at this time, all wells are unused). Then, the start well number display part 63 displays the number (A1 in this case) of the well (the well in which the sample is first measured among the four wells in which the sample is disposed in the individual region 652) located at the upper right of the individual region 652.

Next, the sample position display unit 43 displays wells located at four corners among the five wells located in each of the five individual regions 652 in yellow, indicating the wells in which the standard sample for laser power selection is to be disposed, and displays one well located at the center in purple, indicating the well in which the calibrant is to be disposed. Note that, since the drawings attached to the present specification are monochrome drawings, different colors are indicated by different hatching in FIG. 3 (the same applies to FIG. 4 and subsequent drawings). In addition, each individual region 652 displays, as a label, in a superimposed manner the value (a value obtained by increasing or decreasing a reference value of laser power input by a user by five setting values; 5, 10, 15, 20, 25) of the laser power with which the standard sample and the calibrant disposed in the well in each individual region are irradiated. Note that, in the display example illustrated in FIG. 3, all the items in the display item selection checkbox 653 are checked. The label displayed in a superimposed manner on the individual region 652 differs for each analysis protocol. In a case where different samples are disposed between the individual regions 652, a label related to each sample is displayed as a label, and in a case where the same sample is disposed in each individual region and measurement is performed with different analysis parameters, a value of the parameter is displayed as a label. The analysis protocol of laser power selection corresponds to the latter.

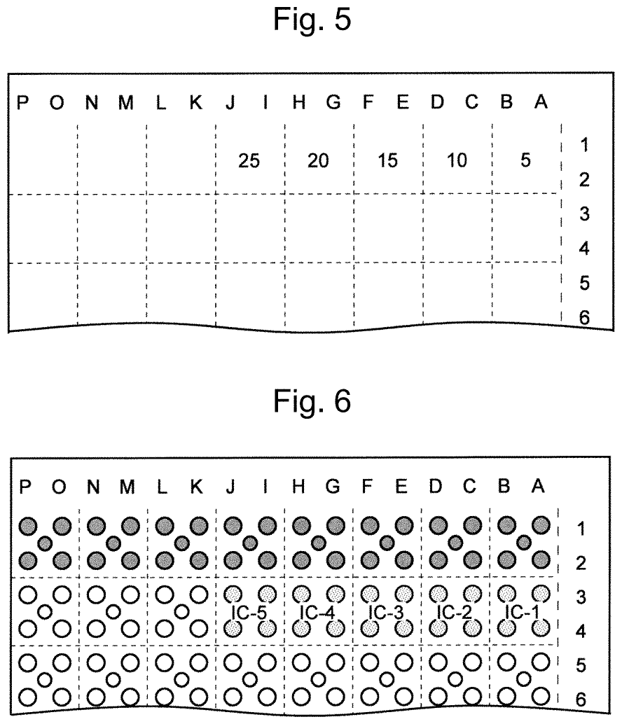

When the display is performed as described above, as illustrated in FIG. 3, the display of the well in each individual region 652 and the display of the value of the analysis parameter (here, the candidate value of the laser power value) overlap with each other, which makes it difficult to confirm the well in which the calibrant is disposed. Therefore, in the present embodiment, the user can change the display form by appropriately selecting the item of the display item selection checkbox 653. FIG. 4 is a display example in a state in which a well and a calibrant well are selected in the display item selection checkbox 653, and FIG. 5 is a display example in a state in which only a label is selected in the display item selection checkbox 653. When the user changes the item to be selected in the display item selection checkbox 653, the display switching unit 44 changes the display form in this manner.

The user checks the information displayed on the sample plate schematic display area 651 by the sample position display unit 43, and disposes the standard sample and the calibrant in each well of the sample plate 23. Thereafter, when the file creation button 66 is pressed, a batch file for executing an analysis protocol of laser power selection is created by the batch file creation unit 47 and stored in the storage unit 41.

After creating the batch file, the user sets the sample plate 23 on the sample stage 22. When the user instructs to start the measurement, the measurement execution unit 48 reads the batch file from the storage unit 41 and starts the measurement. After the start of the measurement, laser light having an intensity of the first candidate value (5) is emitted to the calibrant disposed in the first individual region 652, and the mass spectrometer is mass-calibrated by collating the detection result of the generated ions with the actual mass-to-charge ratio of the ions. The mass calibration is performed by, for example, changing a time-of-flight to mass-to-charge ratio conversion table included in the mass spectrometer or stored in advance in the storage unit 41. After the measurement of the calibrant, each of the standard samples disposed in four wells (A1, A2, B1, B2) in the same individual region 652 is also irradiated with laser light having the same intensity (5) to generate ions, which are mass-separated and detected by the detector 29. The output signals from the detector 29 are sequentially stored in the storage unit 41. In the same manner as described above, the laser light having the intensity of the candidate value corresponding to each of the remaining four individual regions is emitted to perform the mass spectrometry.

After completing the measurement of all the individual regions 652, the inspection processing unit 49 averages the detection intensities of the ions obtained by four times of the mass spectrometry for each individual region 652, and calculates the detection intensities of the ions having the mass-to-charge ratio characteristic of the two types of peptides to be measured. Then, the detection sensitivity of the ion with respect to the laser light having the intensity is obtained. Then, a laser power candidate value (here, 20 is used as an example) is determined and stored in the storage unit 41, with which ions derived from the two types of peptides can be detected with a sensitivity equal to or higher than a predetermined reference and the total detection sensitivity of ions derived from the two types of peptides is maximized.

In addition, the information regarding implementation of the protocol for laser intensity selection is displayed on the analysis protocol implementation information display area 612 of the analysis protocol selection part 61. In the present embodiment, “Inspection was performed on 2020/**/**. The intensity ratio calibration, standard plasma analysis, and specimen analysis are measured with laser power 20” is displayed. The value of laser power is a value determined based on a result of executing an analysis protocol of laser power selection.

Further, the protocol execution information collection unit 45 records that the analysis protocol of laser power selection has been executed (for example, the information is updated by adding a flag indicating that the analysis protocol of the laser power selection stored in the storage unit 41 has been executed).

When the analysis protocol of laser power selection is completed, the user takes out the sample plate 23 from the analysis unit 2. When the user selects the selection button 611 of the analysis protocol (intensity ratio calibration) to be executed next, the input of the analysis protocol of the intensity ratio calibration is received by the protocol selection input reception unit 42. When the analysis protocol is selected, the determination unit 46 reads information on the implementation order of the analysis protocols stored in the storage unit 41. Intensity ratio calibration is the analysis protocol executed after the analysis protocol of laser power selection. Therefore, the determination unit 46 confirms whether the analysis protocol (laser power selection) to be executed beforehand has been executed. As described above, the protocol execution information collection unit 45 records that the analysis protocol of laser power selection has been executed. After confirming whether the analysis protocol (laser power selection) to be executed beforehand has been executed, the determination unit 46 finishes the operation. On the other hand, when the analysis protocol (laser power selection) to be executed beforehand has not been executed, a message indicating that the laser power selection has not been executed is displayed on the display unit 6 to prompt the user to confirm.

Next, the sample position display unit 43 reads, from the storage unit 41, the information on the sample and the analysis parameter corresponding to the analysis protocol (intensity ratio calibration) received by the protocol selection input reception unit 42. As described above, for the intensity ratio calibration protocol, analysis parameters including the use of five types of standard samples (IC-1, IC-2, IC-3, IC-4, IC-5) having different contents of the peptide to be measured and laser power (20) based on the inspection result of the analysis protocol of laser power selection are stored. Upon reading these pieces of information, the sample position display unit 43 displays these pieces of information at the position of the well in which the sample is to be disposed in the sample plate schematic display area 651.

A display example of the sample plate schematic display area 651 by the sample position display unit 43 is illustrated in FIG. 6. At this point, five individual regions 652 provided on the sample plate 23 are used in the laser power selection analysis protocol. When the used individual regions 652 exist in this manner, the sample position display unit 43 treats all the individual regions 652 disposed in the lateral direction as used ones, and displays all the wells inside these individual regions 652 in gray, indicating that they are unusable.

Subsequently, the sample position display unit 43 extracts five individual regions arranged in the lateral direction with the individual region 652 positioned at the upper right corner as the first region among the unused individual regions 652. Then, the start well number display unit 63 displays the number (A3 in this case) of the well located at the upper right of the individual region 652.

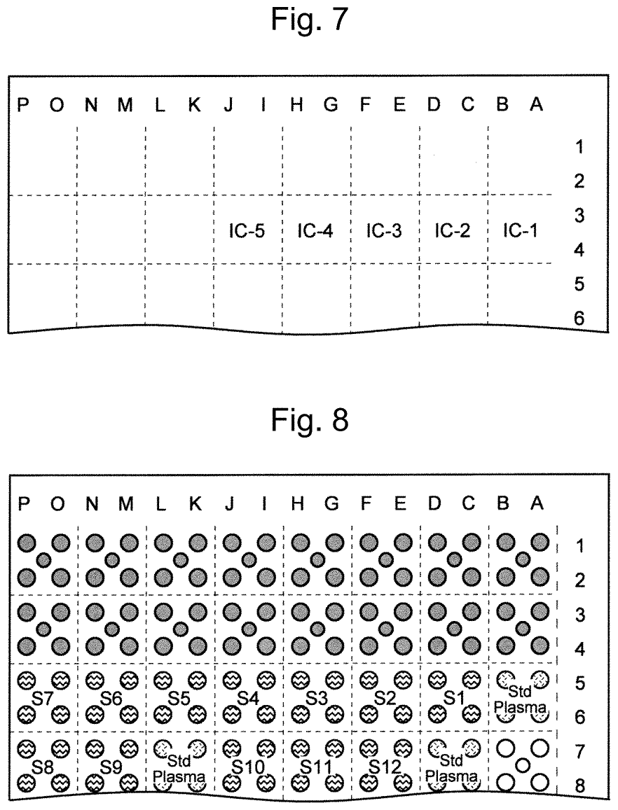

Next, the sample position display unit 43 displays wells located at four corners among the five wells located in each of the five individual regions 652 in green, indicating the wells in which the standard sample for intensity ratio calibration is to be disposed, and displays one well located at the center in purple, indicating the well in which the calibrant is to be disposed. Also in FIG. 6, different colors are indicated by different hatching as in FIGS. 3 and 4. In addition, in each of individual regions 652, the names (IC-1, IC-2, IC-3, IC-4, IC-5) of the standard sample to be disposed in the well in the individual region 652 are displayed, as labels, in a superimposed manner. Note that, in the display example illustrated in FIG. 6, all the items in the display item selection checkbox 653 are checked. Similarly to FIGS. 3 to 5, the user can change the display form by appropriately selecting the item of the display item selection checkbox 653. FIG. 7 illustrates a display example in a case where only a label is selected among the items of the display item selection checkbox 653.

The user checks the information displayed on the sample plate schematic display area 651 by the sample position display unit 43, and disposes five types of standard samples and the calibrants for intensity ratio calibration in each well of the sample plate 23. Thereafter, when the file creation button 66 is pressed, a batch file for executing an analysis protocol of the intensity ratio calibration is created by the batch file creation unit 47 and stored in the storage unit 41.

After creating the batch file, the user sets on the sample stage 22 the sample plate 23 in which five types of standard samples and calibrants are disposed in predetermined wells. When the user instructs to start the measurement, the measurement execution unit 48 reads the batch file from the storage unit 41 and starts the measurement. Since the measurement procedure is similar to that when the laser power selection is performed described above, the description will be omitted. However, in the intensity ratio calibration, all the samples and the calibrant are irradiated with laser light having the same intensity (laser power 20).

After completing the measurement of all the individual regions 652, the inspection processing unit 49 averages the detection intensities of the ions obtained by four times of the mass spectrometry for each individual region 652, and obtains the relationship between the content of the target substance contained in the standard sample and the detection intensities of the ions, from the detection intensities of the ions at a predetermined mass-to-charge ratio (typically, the mass-to-charge ratio of the ions characteristic of two types of peptides). Then, a correction value of the detection intensity is determined so that the detection intensity of the ions of the target substance of each specified amount becomes a predetermined intensity, and is stored in the storage unit 41.

In addition, the information regarding execution of the protocol for the intensity ratio calibration is displayed on the analysis protocol implementation information display area 612 of the analysis protocol selection unit 61. In the present embodiment, “Inspection was executed on 2020/**/**” is displayed.

Further, the protocol execution information collection unit 45 records that the analysis protocol of the intensity ratio calibration has been executed (for example, the information is updated by adding a flag indicating that the analysis protocol of the intensity ratio calibration stored in the storage unit 41 has been executed).

When the analysis protocol of the intensity ratio calibration is completed, the user takes out the sample plate 23 from the analysis unit 2. When the user selects an analysis protocol to be executed next (standard plasma analysis or specimen analysis can be performed. Here, the specimen analysis is performed with the standard plasma analysis omitted), the input of the analysis protocol of the specimen analysis is received by the protocol selection input reception unit 42. When the analysis protocol is selected, the determination unit 46 reads information on the implementation order of the analysis protocols stored in the storage unit 41. Specimen analysis is an analysis protocol executed after an analysis protocol of laser power selection and intensity ratio calibration. Therefore, the determination unit 46 confirms whether the analysis protocol (laser power selection and intensity ratio calibration) to be executed beforehand has been executed. As described above, the protocol execution information collection unit 45 records that the analysis protocol of laser power selection has been executed. After confirming whether the analysis protocol (laser power selection and intensity ratio calibration) to be executed beforehand has been executed, the determination unit 46 finishes the operation. On the other hand, when the analysis protocol (laser power selection and/or intensity ratio calibration) to be executed beforehand has not been executed, the analysis protocol that has not been executed is displayed on the display unit 6 to prompt the user to execute the analysis protocol.

Next, the sample position display unit 43 reads, from the storage unit 41, the information on the sample and the analysis parameter corresponding to the analysis protocol (specimen analysis) received by the protocol selection input reception unit 42. As described above, analysis parameters including the use of the standard plasma and plasma extracted from blood collected from an unexamined subject (in this example, 12 unexamined measurement target samples 1 to 12) and including the laser power (20) based on the inspection result of the analysis protocol for the laser power selection are stored. Upon reading these pieces of information, the sample position display unit 43 displays these pieces of information at the position of the well in which the sample is to be disposed in the sample plate schematic display area 651. However, the sample name of the measurement target sample may include many contents such as the collection date, the name of the subject, the sex, and the age. It is difficult to display such a long sample name in the limited individual region 652. Therefore, in the present embodiment, the sample name display table 641 is configured to display the correspondence relationship of the reference sign (S1, S2, . . . ) for displaying the above sample name, and the sample plate schematic display area 651 is configured to display the reference sign for displaying as a label in a superimposed manner.

A display example of the sample plate schematic display area 651 by the sample position display unit 43 is illustrated in FIG. 8. Here, similarly to the above example, the sample position display unit 43 treats all the individual regions 652 in the row in which the used individual regions 652 exist as used ones, and displays all the wells inside these individual regions 652 in gray indicating that they are unusable.

Subsequently, the sample position display unit 43 extracts, as a first region, the individual regions 652 located at the upper right corner among the unused individual regions 652, and extracts 15 individual regions 652 disposed in a predetermined order from the first region. The number of measurement target samples is 12, but in the present embodiment, measurement is performed in the order of first measuring the standard plasma, then continuously measuring a predetermined number (here, nine as an example) of measurement target samples, and then measuring the standard plasma again, and after measuring the last measurement target sample, the standard plasma is measured again. Therefore, the sample position display unit 43 extracts 15 individual regions 652 (individual regions in which one standard plasma, nine measurement target samples, one standard plasma, three measurement target samples, and one standard plasma are disposed). In addition, after the sample in the individual region 652 located at the end in the row direction is measured, the sample in the individual region 652 adjacent below the individual region 652 is measured. That is, when the measurement is performed across the rows, the individual regions 652 are sequentially measured in a folding back manner (right to left in the first row, and left to right in the next row). Therefore, the sample position display unit 43 also extracts 15 individual regions 652 in this measurement order. Then, the start well number display part 63 displays the number (A5 in this case) of the well (the well in which the sample is measured first among the four wells in which the sample is disposed in the individual region 652) located at the upper right of the individual region 652.

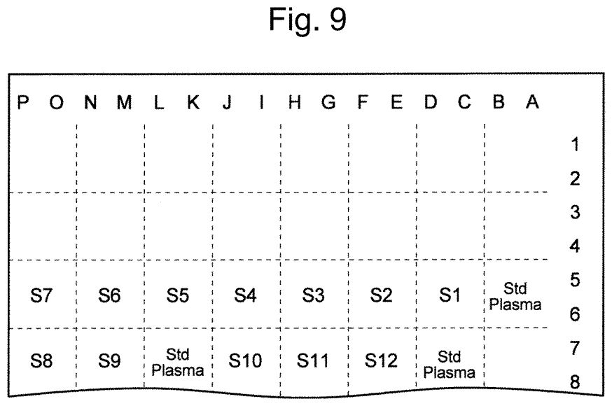

Next, the sample position display unit 43 displays the wells located at the four corners among the five wells located in the first individual region 652, the eleventh individual region 652, and the fifteenth individual region 652 in blue, indicating the wells in which standard plasma is to be disposed, and displays one well located at the center in purple, indicating the well in which a calibrant is to be disposed. In addition, among the five wells located in each of the second to tenth individual regions 652, wells located at four corners are displayed in red, indicating the wells in which a measurement target sample (plasma of an unexamined subject) is placed, and one well located at the center is displayed in purple, indicating that the well in which a calibrant is disposed. Also in FIG. 8, different colors are indicated by different hatching as in FIGS. 3, 4, and 6. In addition, in the individual region 652 in which the standard plasma is disposed, a label (StdPlasma) indicating that the standard plasma is displayed in a superimposed manner, and in the individual region 652 in which the measurement target samples (measurement target samples 1 to 12) are disposed, a display code (S1, S2, S3, . . . , S12) associated with the sample name of the measurement target sample to be disposed in the well in the individual region 652 is displayed in a superimposed manner as a label. The display example illustrated in FIG. 8 is in a state where all the items of the display item selection checkbox 653 are checked, and similarly to the above, the user can change the display form by appropriately selecting the items of the display item selection checkbox 653. FIG. 9 illustrates a display example in a case where only a label is selected among the items of the display item selection checkbox 653.

The user checks the information displayed on the sample plate schematic display area 651 by the sample position display unit 43, and disposes the standard plasma, the measurement target samples 1 to 12, and the calibrant in each well of the sample plate 23. Thereafter, when the file creation button 66 is pressed, a batch file for executing an analysis protocol of specimen analysis is created by the batch file creation unit 47 and stored in the storage unit 41.

After creating the batch file, the user sets on the sample stage 22 the sample plate 23 in which the standard plasma, the measurement target samples 1 to 12, and the calibrant are disposed in predetermined wells. When the user instructs to start the measurement, the measurement execution unit 48 reads the batch file from the storage unit 41 and starts the measurement. The description of the procedure for measuring the calibrant and the standard plasma/measurement target samples disposed in the well in the individual region 652 is omitted because the procedure is similar to that when the laser power selection is performed. Similarly to the intensity ratio calibration, in the specimen analysis, all the samples and the calibrant are irradiated with the laser light having the same intensity (laser power 20).

In the specimen analysis, first, detection intensities of ions derived from the two types of peptides obtained for standard plasma are corrected by a correction value calculated by an analysis protocol of intensity ratio calibration. Then, it is confirmed that the corrected ratio of the detection intensities of the ions derived from the two types of peptides is within an allowable range from a predetermined value. When this is within the allowable range, the measurement target sample in the adjacent individual region 652 is measured. After measurement of the measurement target samples 1 to 9, the standard plasma is measured again in the same manner as described above. When the corrected ratio of the detection intensities of the ions derived from the two types of peptides is out of the allowable range from the predetermined value, the display unit 6 displays the fact that the abnormality has occurred in the measurement result of the standard plasma after the measurement is completed (the ratio of the detection intensities of the ions is out of the allowable range from the predetermined value).

After completing the measurement of all the individual regions 652, the inspection processing unit 49 averages the detection intensities of the ions obtained by four times of the mass spectrometry for each individual region 652 in which the measurement target sample is disposed, and extracts the detection intensities of the ions having a predetermined mass-to-charge ratio (mass-to-charge ratio of ions characteristic of two types of peptides). Then, the intensity value is corrected by the correction value calculated in the analysis protocol of the intensity ratio calibration. The intensity values of ions before and after correction obtained for each measurement target sample are stored in the storage unit 41. The description of subsequent inspection processing based on these intensity values is omitted because the processing is similar to that in Patent Literature 1.

As described above, in the analysis system 1 of the present embodiment, when each analysis protocol is executed, the sample position display unit 43 displays the information on the position of the well in which the sample is to be disposed and the information on the sample to be disposed in the sample plate schematic display area 651. Therefore, when trying to execute each protocol, the user can easily confirm which sample is to be disposed at which position, and correctly dispose the sample. In addition, as illustrated in FIG. 3, even in a case where the display of the wells in each individual region 652 and the display of the value of the analysis parameter (here, the candidate value of the laser power value) overlap with each other, which makes it difficult to confirm the well in which the calibrant is disposed, or the like, it is possible to improve the visibility by appropriately changing the selection of the item of the display item selection checkbox 653 and displaying what the user desires to confirm on the display unit 6.

In the analysis system 1 of the present embodiment, when the execution of each analysis protocol is recorded by the protocol execution information collection unit 45 and the user selects an analysis protocol, the determination unit 46 confirms whether an analysis protocol to be executed before the analysis protocol is completed, and then the batch file creation unit 47 creates a batch file for executing the analysis protocol. In other words, when the user selects another protocol without executing the protocol to be executed beforehand, a batch file for executing the protocol is not created. Thus, it is possible to cause the user to execute the plurality of protocols in the correct order.

Further, in the analysis system 1 of the present embodiment, the sample position display unit 43 treats all the individual regions 652 arranged in a row in which the used individual regions 652 exist as used ones, and starts the individual region 652 located at the right end of the next row, which makes it possible to reduce the possibility that the user erroneously locates the individual region 652 in which the sample is to be disposed first.

Further, in the analysis system 1 of the present embodiment, the wells in the individual regions 652 are displayed in colors corresponding to the types of samples to be disposed in the wells, which makes it possible to reduce the possibility of erroneous disposing of the samples. In addition, when the same sample is disposed in each individual region 652 and measurement is performed with different analysis parameters as in an analysis protocol of laser power selection, a value of the parameter is displayed as a label, and when different samples are disposed between the individual regions 652 as in an analysis protocol of intensity ratio calibration or specimen analysis, a label regarding each sample is displayed. Therefore, the user can easily confirm what kind of sample is disposed in which individual region 652 and what kind of analysis parameter is used for measurement.

The above-described embodiment is merely an example, and can be appropriately modified in accordance with the spirit of the present invention. In the above embodiment, the analysis system 1 includes the MALDI-TOF mass spectrometer, but an appropriate analysis device can be used depending on the purpose and content of analysis.

In addition, in the above embodiment, the analysis work support device and the analysis work support program are incorporated in a part of the control/processing unit 4, but both can be configured independently of each other.

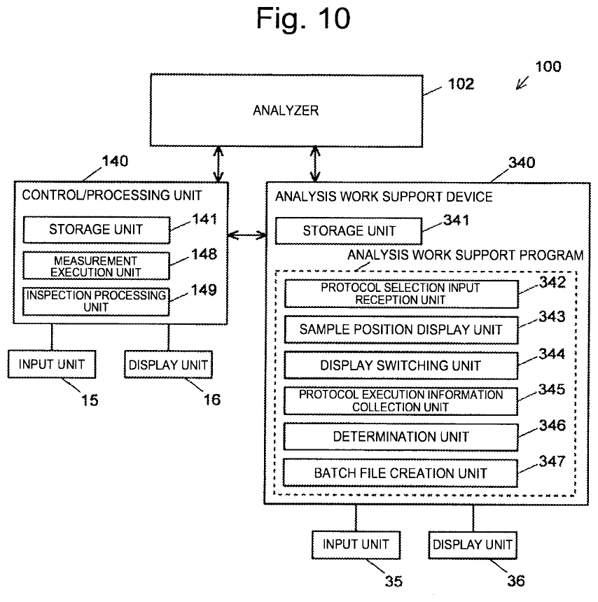

FIG. 10 illustrates a configuration of a main part of an analysis system 100 of a variation. The analysis system 100 of the variation includes an analyzer 102, a control/processing unit 140, and an analysis work support device 340, which can communicate with one another. The analyzer 102 may be the same mass spectrometer as in the above embodiment, or may be another type of analyzer.

The control/processing unit 140 mainly controls operation of each unit of the analyzer 102 and performs inspection processing. The control/processing unit 140 includes as functional blocks a measurement execution unit 148 and an inspection processing unit 149 in addition to a storage unit 141. The description of specific functions of the measurement execution unit 148 and the inspection processing unit 149 are omitted because the functions are similar to those of the above-described embodiment. An entity of the control/processing unit 140 is a general computer, and the above-described functional blocks are embodied by a processor executing an analysis program installed in advance. In addition, an input unit 15 and a display unit 16 are connected to the control/processing unit 140.

The analysis work support device 340 supports the analysis work by the user, particularly disposing work of a sample on a sample plate 23. In addition to a storage unit 341, the analysis work support device 340 includes, as functional blocks, a protocol selection input reception unit 342, a sample position display unit 343, a display switching unit 344, a protocol execution information collection unit 345, a determination unit 346, and a batch file creation unit 347. The description of specific functions of these functional blocks are omitted because the functions are similar to those of the above-described embodiment. Note that the entity of the analysis work support device 340 is a general personal computer, and each functional block described above is embodied by a processor executing an analysis program installed in advance. In addition, an input unit 35 and a display unit 36 are connected to the analysis work support device 340.

The information stored in the storage unit 41 of the analysis system 1 of the above embodiment is stored in one or both of the storage unit 141 of the control/processing unit 140 and the storage unit 341 of the analysis work support device 340. In a case where the same information is stored in both the storage units 141 and 341, it suffices if the update of the information in the storage units is synchronized.

### Modes

It is understood by those skilled in the art that the plurality of exemplary embodiments described above are specific examples of the following modes.

(Clause 1)

One mode is a device which supports analysis work of executing a protocol for disposing a predetermined sample in all or some predetermined sample disposing portions among a plurality of sample disposing portions provided in a sample housing member set in an analysis device and for performing measurement, the device including:
a storage unit in which a plurality of protocols, and information on a position of the sample disposing portion and the sample corresponding to each of the plurality of protocols are stored;
a display unit;
a protocol selection input reception unit configured to receive an input for selecting one of the plurality of protocols;
a sample position display unit configured to read, from the storage unit, information on a position of the sample disposing portion and information on the sample corresponding to the protocol input to the protocol selection input reception unit and display the information on the position and the information on the sample on the display unit;
a display item selection unit configured to receive selection of one or both of the information on the position of the sample disposing portion and the information on the sample; and
a display switching unit configured to switch display of the display unit by the sample position display unit depending on selection through the display item selection unit.

(Clause 6)

In addition, another mode is a program which supports analysis work of executing a protocol for disposing a predetermined sample in all or some predetermined sample disposing portions among a plurality of sample disposing portions provided in a sample housing member set in an analysis device and for performing measurement, the program causing a computer including
a storage unit in which a plurality of protocols, and information on a position of the sample disposing portion and the sample corresponding to each of the plurality of protocols are stored, and
a display unit
to operate as:
a protocol selection input reception unit configured to receive an input for selecting one of the plurality of protocols;
a sample position display unit configured to read, from the storage unit, information on a position of the sample disposing portion and information on the sample corresponding to the protocol input to the protocol selection input reception unit and display the information on the position and the information on the sample on the display unit;
a display item selection unit configured to receive selection of one or both of the information on the position of the sample disposing portion and the information on the sample; and
a display switching unit configured to switch display of the display unit by the sample position display unit depending on selection through the display item selection unit.

The analysis work support device according to clause 1 and the analysis work support program according to clause 6 support analysis work of executing a protocol for disposing a predetermined sample in all or some predetermined sample disposing portions among a plurality of sample disposing portions provided in a sample housing member set in an analysis device and for performing measurement. The storage unit stores in advance a plurality of protocols including the information on a sample to be measured and the information on a position of a sample disposing portion in which the sample is to be disposed. When the user selects one of the plurality of protocols stored in the storage unit in advance, the sample position display unit reads, from the storage unit, information on a position of the sample disposing portion and information on the sample corresponding to the protocol, and displays them on the display unit. For example, in a case of a sample plate provided with a plurality of sample disposing portions in a lattice pattern, the information on the sample is displayed by the number of samples to be disposed according to the protocol with the sample disposing portion located at the upper right end on the screen as a base point when the sample plate is displayed in a predetermined direction. Therefore, when trying to execute each protocol, the user can easily confirm which sample is to be disposed at which position, and correctly dispose and measure the sample.

In addition, the user can display what the user wants to confirm on the display unit by selecting one or both of the information on the position of the sample disposing portion and the information on the sample. For example, in a case where the information on the sample is text information, if both the information on the position of the sample disposing portion and the text information on the sample are displayed, both pieces of information may overlap each other, and thus it may be difficult to confirm them. In the analysis work support device according to clause 1 and the analysis work support program according to clause 6, by selecting one or both of the information on the position of the sample disposing portion and the information on the sample through the display item selection unit, the display of the display unit can be switched to enhance the visibility of the item to be confirmed by the user.

(Clause 2)

The analysis work support device according to clause 1, wherein
the plurality of sample disposing portions are provided in a lattice pattern, and
when any one of the sample disposing portions arranged in a predetermined direction is used, the sample position display unit is configured to treat all the sample disposing portions arranged in the direction as used ones and to display the used sample disposing portions distinguishably from an unused sample disposing portion.

In the analysis work support device according to clause 2, all the rows or columns arranged in the predetermined direction described above are treated as used ones, which makes it possible to reduce the possibility that the user erroneously uses the base point of the position where the sample is to be disposed.

(Clause 3)

The analysis work support device according to clause 2, wherein
the sample position display unit is configured to display the information on the sample to be disposed with a sample disposing portion positioned at a predetermined corner portion among unused sample disposing portions as a base point.

In the analysis work support device according to clause 3, the sample is always disposed from the sample disposing portion located at the predetermined corner portion regardless of the protocol, which makes it possible to further reduce the possibility that the user erroneously uses the base point of the position where the sample is to be disposed.

(Clause 4)

The analysis work support device according to any one of clauses 1 to 3, wherein
the sample position display unit is configured to identifiably display the sample disposing portions depending on a type of the sample to be disposed.

When a plurality of protocols are executed, not only an actual measurement target sample but also a standard sample depending on a purpose of each protocol may be measured. In the analysis work support device according to clause 4, the sample disposing portion is displayed in an identifiable manner depending on the type of the sample, which makes it possible to reduce the possibility of erroneous disposing of the samples.

(Clause 5)

The analysis work support device according to any one of clauses 1 to 4, wherein
in a case where different samples of the same type are included in a sample to be disposed, the sample position display unit is configured to display text information for specifying the different samples.

When a measurement target sample collected from each of a plurality of subjects or when a standard sample containing different specified amounts of a target substance is measured, the types of samples are the same. In the analysis work support device according to clause 5, in a case where different samples of the same type are disposed as described above, the text information that can identify the samples from each other is displayed, which makes it possible to correctly dispose these samples.

### REFERENCE SIGNS LIST

1, 100 . . . Analysis System
102 . . . Analyzer
2 . . . Analysis Unit
22 . . . Sample Stage
23 . . . Sample Plate
26 . . . Laser Irradiation Unit
27 . . . Mirror
28 . . . Flight Tube
29 . . . Detector
4, 140 . . . Control/Processing Unit
41, 141, 341 . . . Storage Unit
42, 342 . . . Protocol Selection Input Reception Unit
43, 343 . . . Sample Position Display Unit
44, 344 . . . Display Switching Unit
45, 345 . . . Protocol Execution Information Collection Unit
46, 346 . . . Determination Unit
47, 347 . . . Batch File Creation Unit
48, 148 . . . Measurement Execution Unit
49, 149 . . . Inspection Processing Unit
5, 15, 35 . . . Input Unit
6, 16, 36 . . . Display Unit
61 . . . Analysis Protocol Selection Part
611 . . . Selection Button
612 . . . Analysis Protocol Implementation Information Display Area
62 . . . Data Set Name Input Unit
63 . . . Start Well Number Display Unit
64 . . . Sample Information Display Unit
641 . . . Sample Name Display Table
642 . . . Data Editing Button
65 . . . Sample Plate Display Unit
651 . . . Sample Plate Schematic Display Area
652 . . . Individual Region
653 . . . Display Item Selection Checkbox
66 . . . File Creation Button

1. An analysis work support device which supports analysis work of executing a protocol for disposing a predetermined sample in all or some predetermined sample disposing portions among a plurality of sample disposing portions provided in a sample housing member set in an analysis device and for performing measurement, the analysis work support device comprising:
a storage unit in which a plurality of protocols, and information on a position of the sample disposing portion and the sample corresponding to each of the plurality of protocols are stored;
a display unit;
a protocol selection input reception unit configured to receive an input for selecting one of the plurality of protocols;
a sample position display unit configured to read, from the storage unit, information on a position of the sample disposing portion and information on the sample corresponding to the protocol input to the protocol selection input reception unit and display the information on the position and the information on the sample on the display unit;
a display item selection unit configured to receive selection of one or both of the information on the position of the sample disposing portion and the information on the sample; and
a display switching unit configured to switch display of the display unit by the sample position display unit depending on selection through the display item selection unit.

2. The analysis work support device according to claim 1, wherein
the plurality of sample disposing portions are provided in a lattice pattern, and
when any one of the sample disposing portions arranged in a predetermined direction is used, the sample position display unit is configured to treat all the sample disposing portions arranged in the direction as used ones and to display the used sample disposing portions distinguishably from an unused sample disposing portion.

3. The analysis work support device according to claim 2, wherein the sample position display unit is configured to display the information on the sample to be disposed with a sample disposing portion positioned at a predetermined corner portion among unused sample disposing portions as a base point.

4. The analysis work support device according to claim 1, wherein the sample position display unit is configured to identifiably display the sample disposing portions depending on a type of the sample to be disposed.

5. The analysis work support device according to claim 1, wherein in a case where different samples of a same type are included in the sample to be disposed, the sample position display unit is configured to display text information for specifying the different samples.

6. A non-transitory computer-readable storage medium storing an analysis work support program which supports analysis work of executing a protocol for disposing a predetermined sample in all or some predetermined sample disposing portions among a plurality of sample disposing portions provided in a sample housing member set in an analysis device and for performing measurement, the analysis work support program causing a computer including
a storage unit in which a plurality of protocols, and information on a position of the sample disposing portion and the sample corresponding to each of the plurality of protocols are stored, and
a display unit
to operate as:
a protocol selection input reception unit configured to receive an input for selecting one of the plurality of protocols;
a sample position display unit configured to read, from the storage unit, information on a position of the sample disposing portion and information on the sample corresponding to the protocol input to the protocol selection input reception unit and display the information on the position and the information on the sample on the display unit;
a display item selection unit configured to receive selection of one or both of the information on the position of the sample disposing portion and the information on the sample; and
a display switching unit configured to switch display of the display unit by the sample position display unit depending on selection through the display item selection unit.
